(19) United States
(12) Patent Application Publication
(10) Pub. No.: US 2024/0022026 A1
(43) Pub. Date: Jan. 18, 2024

(54) TRANSMISSION BOARD AND CONNECTING MEMBER

(71) Applicant: LOTES CO., LTD, Keelung (TW)

(72) Inventors: Chu Hua Pan, Keelung (TW); Rong Zhong Shu, Keelung (TW)

(21) Appl. No.: 18/220,384

(22) Filed: Jul. 11, 2023

(30) Foreign Application Priority Data
Jul. 15, 2022 (CN) 202210854577.3

(51) Int. Cl. H01R 13/6587

(52) U.S. Cl. CPC H01R 13/6587

(57) ABSTRACT

A transmission board includes: an insulating carrier; a pair of differential channels, including a first channel and a second channel; and a grounding structure, provided in the insulating carrier. An inner side of the first channel and an inner side of the second channel are separated from and coupled to each other. The first channel has a timing compensation section and a connecting section connected to the timing compensation section. A distance between an inner side of the timing compensation section and the inner side of the second channel is defined as a first distance. A distance between an inner side of the connecting section and the inner side of the second channel is defined as a second distance. The first distance is greater than the second distance. The grounding structure is located between the inner side of the timing compensation section and the inner side of the second channel.

### CROSS-REFERENCE TO RELATED PATENT APPLICATION

This non-provisional application claims priority to and the benefit of, pursuant to 35 U.S.C. § 119(a), patent application Serial No. CN202210854577.3 filed in China on Jul. 15, 2022. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a transmission board and a connecting member, and particularly to a transmission board and a connecting member which may improve transmission time delays of the differential signals and impedance consistency of the differential conductors.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A conventional connecting member includes two signal conductors used to transmit differential signals in pairs. Each signal conductor includes a contact portion, a conductive portion and a connecting portion connecting the contact portion and the conductive portion. Due to various factors, there is a difference between the lengths of the transmission paths of the two signal conductors, further resulting in a relatively larger signal transmission time delay of the two signal conductors, which easily causes the signals to be distorted or misjudged. Thus, the industry generally provides a snake-shaped bending section on the originally shorter signal conductor bulging outward relatively to the originally longer signal conductor, thus prolonging the transmission path of the originally shorter signal conductor, further reducing the difference between the lengths of the transmission paths of the two signal conductors, and reducing the time delay thereof.

However, because the snake-shaped bending section is provided, the gaps between the two signal conductors at different locations thereof may have greater differences, thus resulting in ill consistency of the impedances at different locations of the two signal conductors, which is not conducive to the transmission of a pair of differential signals.

Therefore, a heretofore unaddressed need to design a new transmission board and a connecting member exists in the art to address the aforementioned deficiencies and inadequacies.

### SUMMARY

The present invention is directed to a transmission board, which may extend the transmission path of the first channel of the transmission board by a timing compensation section, thereby reducing the difference of the lengths of the first channel and the second channel and reducing the transmission time delay of a pair of differential signals, and the capacitance effect between the timing compensation section and the second channel is adjusted by the grounding structure, thus adjusting the impedance thereof, improving the impedance consistency of the first channel and the second channel at different locations thereof, and reducing the signal reflection. The present invention is also directed to a connecting member, which similarly reduces the signal transmission time delay of the first conductor and the second conductor by the timing compensation section of the first conductor, and adjusts the capacitance effect between the timing compensation section and the second conductor by the grounding structure, thus adjusting the impedance thereof, and reducing the signal reflection.

To achieve the foregoing objective, the present invention adopts the following technical solutions. A transmission board includes: an insulating carrier; a pair of differential channels, comprising a first channel and a second channel provided in the insulating carrier and adjacent to each other, wherein an inner side of the first channel and an inner side of the second channel are separated from each other and coupled to each other, the first channel has at least one timing compensation section and at least one connecting section connected to the timing compensation section, a distance between an inner side of the timing compensation section and the inner side of the second channel is defined as a first distance, a distance between an inner side of the connecting section and the inner side of the second channel is defined as a second distance, the first distance is greater than the second distance, and the timing compensation section bends toward a direction away from the second channel relative to the connecting section; and at least one grounding structure, provided in the insulating carrier, wherein viewing along a perpendicular direction perpendicular to a board surface of the transmission board, the grounding structure is located between the inner side of the timing compensation section and the inner side of the second channel, and the grounding structure is not located between the inner side of the connecting section and the inner side of the second channel.

In certain embodiments, each of the first channel and the second channel has a contact portion, a conducting portion and a middle portion bending and extending between the contact portion and the conducting portion, an extending direction of the contact portion and an extending direction of the conducting portion are perpendicular to each other, the timing compensation section is located in the middle portion of the first channel, the middle portion of the second channel has a coupling section, an inner side of the coupling section and the inner side of the timing compensation section face each other, a transmission path length of the coupling section is less than a transmission path length of the timing compensation section, and transmission path lengths of the first channel and the second channel are equal to each other.

In certain embodiments, viewing along a side-by-side direction of the timing compensation section and the second channel, the grounding structure and a projection of the inner side of the timing compensation section overlap with each other, and the grounding structure and a projection of the inner side of the second channel overlap with each other; and viewing from an observation direction perpendicular to the side-by-side direction and the perpendicular direction, the grounding structure is located between the inner side of the timing compensation section and the inner side of the second channel.

In certain embodiments, viewing from the perpendicular direction, a distance between an outer side edge of the grounding structure and the inner side of the timing compensation section is equal to a distance between the distance between the outer side edge of the grounding structure and the inner side of the second channel.

In certain embodiments, the grounding structure has an outer side edge provided to be adjacent to the inner side of the timing compensation section, and lines of the inner side of the timing compensation section and lines of the outer side edge correspond with each other.

In certain embodiments, the second channel has a coupling section extending along a straight line, an inner side of the coupling section and the inner side of the timing compensation section face each other, the first channel has at least two connecting sections, and the timing compensation section is connected between the two connecting sections; the timing compensation section comprises a first turning section connected to one of the two connecting sections and extending toward a direction away from the coupling section, a first perpendicular section connected to the first turning section and perpendicular to the coupling section, a second perpendicular section separated from and parallel to the first perpendicular section, a second turning section connecting the second perpendicular section and the other of the two connecting sections, and a linking section connecting the first perpendicular section and the second perpendicular section, and the linking section has a parallel portion parallel to the coupling section; and a distance between the outer side edge of the grounding structure and an inner side of the first turning section, a distance between the outer side edge of the grounding structure and an inner side of the first perpendicular section, a distance between the outer side edge of the grounding structure and an inner side of the parallel portion, a distance between the outer side edge of the grounding structure and an inner side of the second perpendicular section, and a distance between the outer side edge of the grounding structure and an inner side of the second turning section are all equal to one another.

In certain embodiments, the first distance is not less than 1.5 times of the second distance, and the first distance is not greater than 3 times of the second distance.

In certain embodiments, the grounding structure comprises a grounding conducting layer and/or a grounding hole, wherein the grounding conducting layer is parallel to the board surface of the transmission board, the grounding hole is concavely provided along the perpendicular direction, and an inner wall of the grounding hole is provided with a conducting material connected to a ground potential.

Compared with the related art, the transmission board according to certain embodiments of the present invention has the following beneficial effects:

The length of the transmission path of the first channel is extended by the timing compensation section, thus reducing the difference between the length of the transmission path of the first channel and the length of the transmission path of the second channel, thereby reducing the signal transmission time delay of the first channel and the second channel, facilitating processing and analysis of the system to the pairs of differential signals, and reducing the risks of signal loss or distortion. Further, to reduce the effect to the impedance consistency of the first channel and the second channel in the whole transmission paths thereof due to the first distance being greater than the second distance, the present invention utilizes the grounding structure being provided between the timing compensation section and the second channel to provide a reference ground potential between the timing compensation section and the second channel, thus adjusting the capacitance effect between the timing compensation section and the second channel, thereby helping reducing the impedance of the timing compensation section and the impedance of the portion of the second channel correspondingly coupled to the timing compensation section, which facilitates the impedance matching of the first channel and the second channel at different locations thereof, improving the impedance consistency of the first channel and the second channel at different locations thereof, and reducing the signal reflection and loss.

To achieve the foregoing objective, the present invention further adopts the following technical solutions. A connecting member includes: an insulating carrier; a first conductor and a second conductor, configured to support a pair of differential signals, wherein the first conductor and the second conductor are provided to be adjacent to each other and fixed to the insulating carrier, an inner side of the first conductor and an inner side of the second conductor are coupled to each other, each of the first conductor and the second conductor has a contact portion configured to be in contact with a first electrical component, a conducting portion configured to be connected to a second electrical component and a middle portion connecting the contact portion and the conducting portion, the middle portion of the first conductor and the middle portion of the second conductor are located on a same plane, the middle portion of the first conductor has at least one timing compensation section and at least one connecting section connected to the timing compensation section, the timing compensation section bends toward a direction away from the second conductor relative to the connecting section, a distance between an inner side of the timing compensation section and the inner side of the second conductor is defined as a first distance, a distance between an inner side of the connecting section and the inner side of the second conductor is defined as a second distance, and the first distance is greater than the second distance; and a grounding structure, provided in the insulating carrier, wherein viewing along a perpendicular direction perpendicular to the plane, the grounding structure is located between the inner side of the timing compensation section and the inner side of the second conductor, and the grounding structure is not located between the inner side of the connecting section and the inner side of the second conductor.

In certain embodiments, the connecting member is a circuit board, the grounding structure comprises a grounding conductive layer and/or a grounding hole, the grounding conductive layer is parallel to the plane, the grounding hole is concavely provided along the perpendicular direction perpendicular to the plane, and an inner wall of the grounding hole is provided with a conductive material connected to a ground potential.

In certain embodiments, transmission path lengths of the first conductor and the second conductor are equal to each other, a portion of the second conductor and the timing compensation section face each other and are coupled to each other along a side-by-side direction; viewing along the side-by-side direction, the grounding structure and a projection of the inner side of the timing compensation section overlap with each other, and the grounding structure and a projection of the inner side of the second conductor overlap with each other; and viewing from an observation direction perpendicular to the perpendicular direction and the side-by-side direction, the grounding structure is located between the inner side of the timing compensation section and the inner side of the second conductor.

In certain embodiments, viewing along the perpendicular direction perpendicular to the plane, a distance between an outer side edge of the grounding structure and the inner side of the timing compensation section is equal to a distance between the distance between the outer side edge of the grounding structure and the inner side of the second conductor.

In certain embodiments, the grounding structure has an outer side edge provided to be adjacent to the inner side of the timing compensation section, and lines of the inner side of the timing compensation section and lines of the outer side edge correspond with each other.

In certain embodiments, the first conductor and the second conductor are both terminal structures, the connecting member comprises a shielding sheet located at a side of the plane, the shielding sheet is electrically isolated from the first conductor and the second conductor, the shielding sheet is provided with a main body portion and the grounding structure extending from the main body portion toward a separation region between the inner side of the timing compensation section and the inner side of the second conductor.

Compared with the related art, the connecting member according to certain embodiments of the present invention has the following beneficial effects:

The length of the transmission path of the first conductor is extended by the timing compensation section, thus reducing the difference of the length of the transmission path of the first conductor and the length of the transmission path of the second conductor, thereby reducing the signal transmission time delay of the first conductor and the second conductor, facilitating processing and analysis of the system to the pairs of differential signals, and reducing the risks of signal loss or distortion. Further, to reduce the effect to the impedance consistency of the first conductor and the second conductor in the whole transmission paths thereof due to the first distance being greater than the second distance, the present invention utilizes the grounding structure being provided between the timing compensation section and the second conductor to provide a reference ground potential between the timing compensation section and the second conductor, thus adjusting the capacitance effect between the timing compensation section and the second conductor, thereby helping reducing the impedance of the timing compensation section and the impedance of the portion of the second conductor correspondingly coupled to the timing compensation section, which facilitates the impedance matching of the first conductor and the second conductor at different locations thereof, improving the impedance consistency of the first conductor and the second conductor at different locations thereof, and reducing the signal reflection and loss. In addition, the middle portions of the first conductor and the second conductor are located on a same plane, which facilitates the signal coupling of a pair of differential terminals.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of a connecting member according to a first embodiment of the present invention.

FIG. 2 is a plain schematic view of a connecting member viewing from a direction perpendicular to the board surface thereof according to the first embodiment of the present invention.

FIG. 3 is a plain schematic view of middle portions of a first channel and a second channel in a connecting member viewing from a direction perpendicular to the board surface thereof according to the first embodiment of the present invention.

FIG. 4 is an enlarged view of a location A in FIG. 3.

FIG. 5 is a perspective schematic view of two pairs of differential channels according to the first embodiment of the present invention.

FIG. 6 is a partial sectional plain view of a connecting member according to the first embodiment of the present invention.

FIG. 7 is a partial sectional plain view of a connecting member according to a second embodiment of the present invention.

FIG. 8 is a perspective schematic view of a connecting member according to a third embodiment of the present invention.

FIG. 9 is a perspective schematic view of a connecting member according to the third embodiment of the present invention after hiding the insulating carrier.

FIG. 10 is a partial plain view of a connecting member according to the third embodiment of the present invention after hiding the insulating carrier.

FIG. 11 is a partial sectional view of FIG. 10 along a B-B line.

FIG. 12 is an impedance test chart of one of the first channels when a grounding structure of a transmission board includes a grounding conductive layer and a grounding hole according to certain embodiments of the present invention.

FIG. 13 is an impedance test chart of one of the first channels when a grounding structure of a transmission board includes a grounding conductive layer and is without a grounding hole according to certain embodiments of the present invention.

FIG. 14 is an impedance test chart of one of the first channels when a transmission board is not provided with a grounding structure according to certain embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

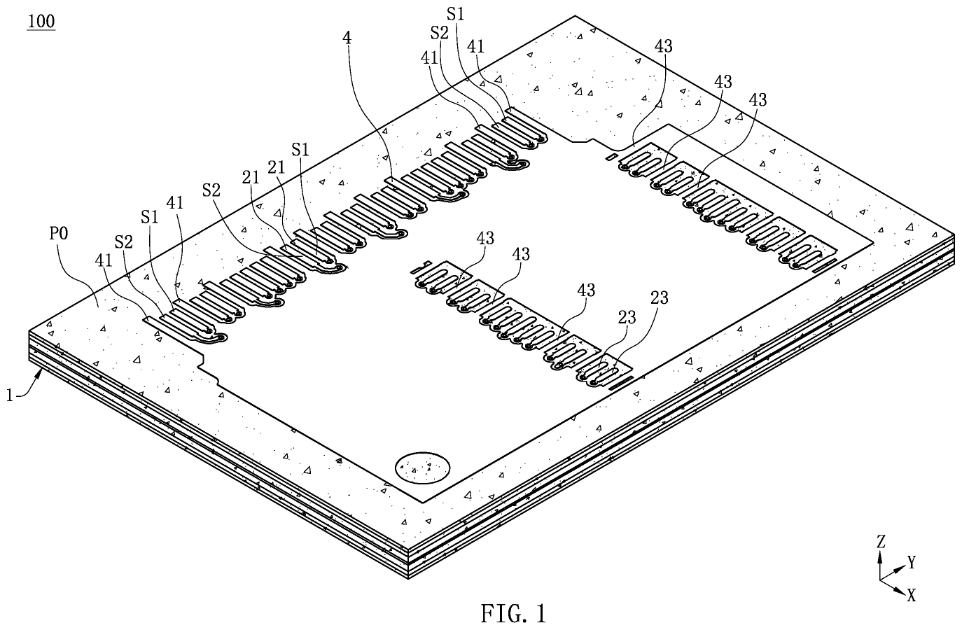

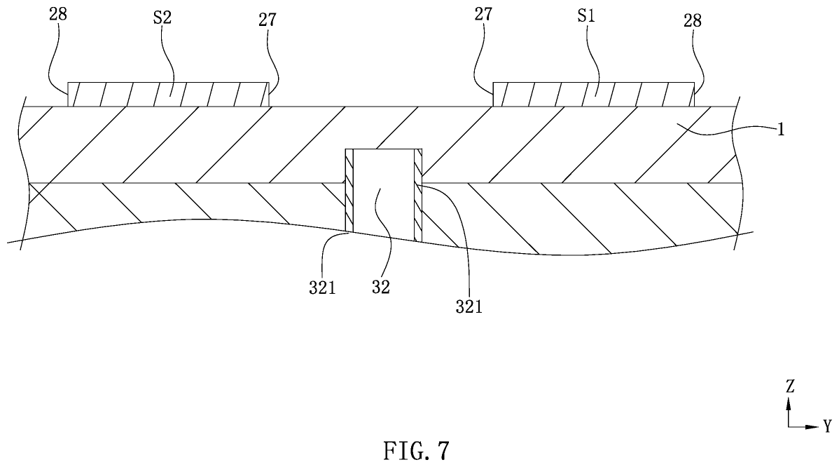

The description will be made as to the embodiments of the present invention in conjunction with the accompanying drawings in FIGS. 1-14. In accordance with the purposes of this invention, as embodied and broadly described herein, this invention, in one aspect, relates to a transmission board and a connecting member.

A connecting member according to certain embodiments of the present invention includes a plurality of pairs of differential conductors, and each pair of the differential conductors includes a first conductor and a second conductor used to support a pair of differential signals. In other embodiments, it is possible to provide only one pair of differential conductors. The connecting member may be of various types. For example, the connecting member may be a transmission board (that is, a circuit board), and the transmission board is formed with a plurality of pairs of differential channels by metal coating layers, such that the pairs of differential channels respectively function as the differential conductors of the connecting member. Alternatively, the connecting member may be a connecting structure having terminals, and the connecting member has a plurality of pairs of differential terminals, such that the pairs of differential terminals respectively function as the differential conductors of the connecting member. In the following description, three embodiments of the present invention are provided to describe the two types of connecting member. However, the connecting member may be of other types in other embodiments.

FIG. 1 to FIG. 6 show a connecting member 100 according to a first embodiment of the present invention. For convenience of understanding the technical solutions of the first embodiment of the present invention, in the accompanying drawings, a three-dimensional coordinate with an X-axis, a Y-axis and a Z-axis is added, and each two of the three axes are perpendicular to each other. In the present embodiment, the connecting member 100 is a transmission board. The transmission board includes an insulating carrier 1 and a plurality of pairs of differential channels 2, and each pair of the differential channels 2 include a first channel S1 and a second channel S2 provided adjacent to each other and used to support a pair of differential signals. An inner side 27 of the first channel S1 and an inner side 27 of the second channel S2 are separated from each other and coupled to each other. The metal coating layers of the transmission board may be a single-layered coating layer, or a dual-sided coating layer, or two or more layers of multi-layered coating layers according to the need. The transmission board may be a mother board provided outside an electrical connector and electrically connected to the electrical connector, or may be a sub board provided inside the electrical connector (for example, the sub board is inside the electrical connector, and the terminals of the electrical connector are connected to the cables through the sub board). The transmission board may further be fixed to the electrical connector and extend toward a mating connector, thus being used to mate with the mating connector.

Referring to FIG. 1 to FIG. 3, each of the first channel S1 and the second channel S2 has a contact portion 21 in contact with a first electrical component (not illustrated, same below), a conductive portion 23 in contact with a second electrical component (not illustrated, same below), and a middle portion 22 connected to the contact portion 21 and the conductive portion 23. In the present embodiment, the contact portion 21 and the conductive portion 23 are located in a first layer, the middle portion 22 is located in a second layer, and the contact portion 21 and the conductive portion 23 are in communication with the middle portion 22 located in the second layer through connecting holes. It should be understood that, in the present embodiment, the middle portion 22 of the first channel S1 and the middle portion 22 of the second channel S2 are located on a same plane P1, and the plane P1 is parallel to a board surface P0 of the transmission board. It should be noted that, in other embodiments, the contact portions 21, the conductive portions 23 and the middle portions 22 of the first channel S1 and the second channel S2 may be distributed in a same layer of the transmission board, or may be distributed in three different layers respectively, without being hereinafter limited thereto.

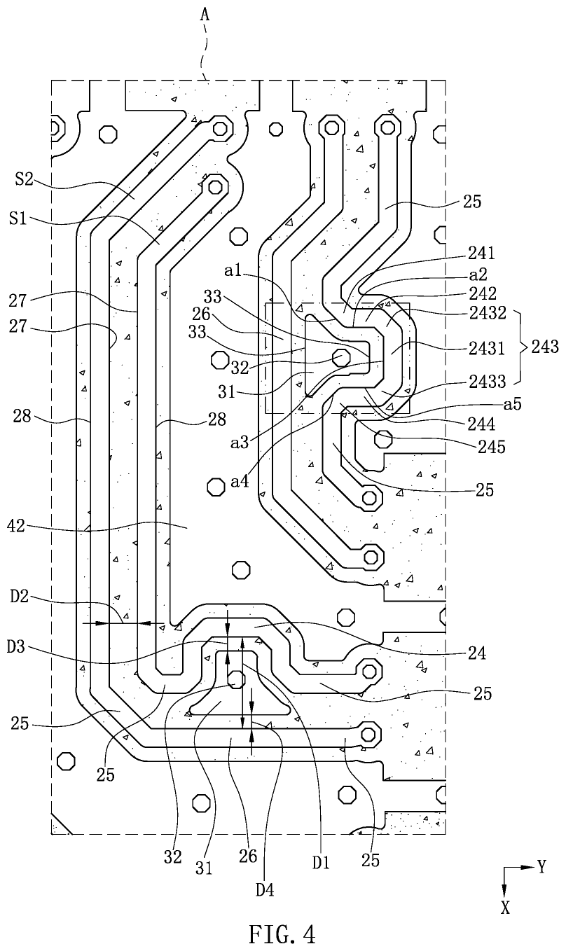

Referring to FIG. 4 to FIG. 6, in the present embodiment, in a pair of the differential channels 2, the first channel S1 has a timing compensation section 24 and two connecting sections 25 connected to the timing compensation section 24. A distance between an inner side 27 of the timing compensation section 24 and the inner side 27 of the second channel S2 (that is, the inner side 27 of the coupling section 26) is defined as a first distance D1, a distance between an inner side 27 of the connecting section 25 and the inner side 27 of the second channel S2 is defined as a second distance D2, and the first distance D1 is greater than the second distance D2. The timing compensation section 24 bends toward a direction away from the second channel S2 relative to the connecting section 25. Specifically, the second channel S2 has a coupling section 26 corresponding to the timing compensation section 24. The inner side 27 of the coupling section 26 and the inner side 27 of the timing compensation section 24 face and are coupled to each other, and the timing compensation section 24 bends toward the direction away from the coupling section 26 relative to the connecting section 25. For convenience of understanding, referring to FIG. 4, in a pair of the differential channels 2, the portion of the first channel S1 located in the dotted-line rectangular area of FIG. 4 is the timing compensation section 24, and the portion of the second channel S2 located in the dotted-line rectangular area of FIG. 4 is the coupling section 26. In other embodiments, the quantity of the timing compensation section 24 of the first channel S1 may be greater than 1, and the quantity of the connecting sections 25 of the first channel S1 may be 1 or greater than 2. One of ordinary skill in the art may provide corresponding quantities of the timing compensation sections 24 and the connecting sections 25 according to actual needs. It should be noted that the timing compensation section 24 may be a smooth arc-shaped structure, or may be a bending and extending structure in a polygonal shape.

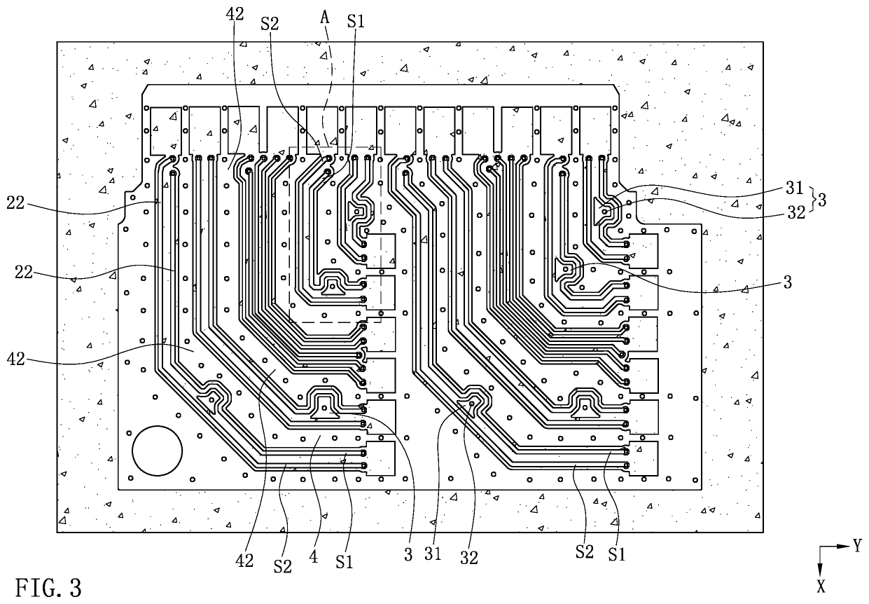

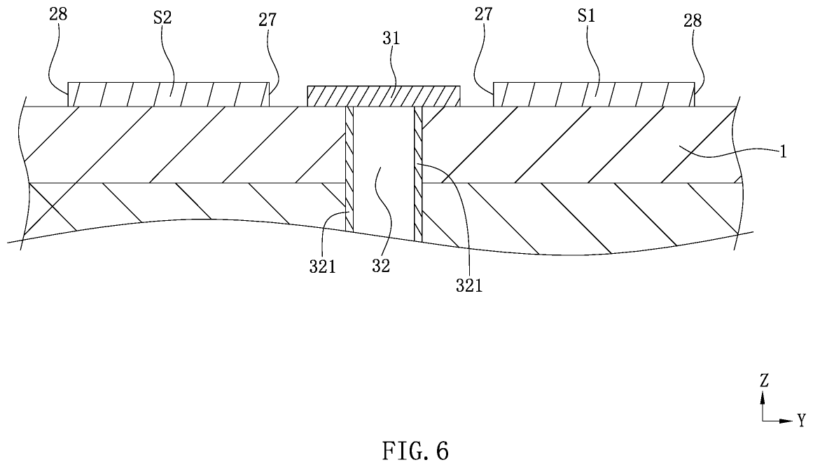

Referring to FIG. 3, FIG. 4 and FIG. 6, the transmission board further has a grounding structure 3 provided in the insulating carrier 1. Viewing along a perpendicular direction perpendicular to the board surface P0 of the transmission board, the grounding structure 3 is located between the inner side 27 of the timing compensation section 24 and the inner side 27 of the second channel S2, and the grounding structure 3 is not located between the inner side 27 of the connecting section 25 and the inner side 27 of the second channel S2. It should be understood that the perpendicular direction is the board thickness direction of the transmission board in the present embodiment, that is, the Z-axis direction of the present embodiment. In the embodiment of the present invention, the length of the transmission path of the first channel S1 is extended by the timing compensation section 24, thus reducing the difference between the length of the transmission path of the first channel S1 and the length of the transmission path of the second channel S2, thereby reducing the signal transmission time delay of the first channel S1 and the second channel S2, facilitating processing and analysis of the system to the pairs of differential signals, and reducing the risks of signal loss or distortion. Since the first distance D1 is greater than the second distance D2, the capacitance effect between the timing compensation section 24 and the second channel S2 is reduced relative to the capacitance effect between the connecting section 25 and the second channel S2, such that the impedance of the timing compensation section 24 and the impedance of the coupling section 26 of the second channel S2 provided corresponding to the timing compensation section 24 are increased, thus resulting in ill consistency of the impedances of the first channel S1 and the second channel S2 in the whole transmission paths thereof and greater signal reflection and loss. In the embodiment of the present invention, by the grounding structure 3 being provided between the timing compensation section 24 and the second channel S2, a reference ground potential is provided between the timing compensation section 24 and the second channel S2, such that a capacitance effect exists between the grounding structure 3 and the timing compensation section 24, a capacitance effect also exists between the grounding structure 3 and the second channel S2, and the grounding structure 3 is conductive, thus adjusting the equivalent dielectric constant of the material surrounding the timing compensation section 24 and the second channel S2. Thus, the capacitance effect between the timing compensation section 24 and the second channel S2 is adjusted, thus helping reducing the impedance of the timing compensation section 24 and the impedance of the coupling section 26 of the second channel S2, which facilitates the impedance matching of the first channel S1 and the second channel S2 at different locations thereof, improving the impedance consistency of the first channel S1 and the second channel S2 at different locations thereof, and reducing the signal reflection and loss. Further, to enable better characteristics of the transmission board, the first distance D1 is not less than 1.5 times of the second distance D2, and the first distance D1 is not greater than 3 times of the second distance D2. That is, (1.5*D2)<D1<(3*D2). Thus, the signal transmission time delay of the pair of differential channels 2 may be reduced, and the impedances of the timing compensation section 24 and the coupling section 26 may be more effectively adjusted, and the engineering practicability may be facilitated.

It should be noted that, when the first channel S1 is not provided with the timing compensation section 24, the length of the transmission path thereof is less than the length of the transmission path of the second channel S2. When the first channel S1 is provided with the timing compensation section 24, it is possible that as described in the embodiment, the length of the transmission path of the first channel S1 and the length of the transmission path of the second channel S2 are provided to be equal. In other embodiments, it is possible that the transmission path of the first channel S1 and the transmission path of the second channel S2 are not provided with equal lengths, but compared to the case where the timing compensation section 24 is not provided, the difference between the lengths of the transmission paths of the pair of differential channels 2 may be reduced. Thus, it is understood that the present invention does not require the timing compensation section 24 to fully eliminate the difference between the lengths of the transmission paths of the first channel S1 and the second channel S2, and compared to the case where the timing compensation section 24 is not provided, it is feasible as long as the difference between the lengths of the transmission paths of the pair of differential channels 2 is reduced, thus achieving certain compensation to the receiving time sequence of the pair of differential signals.

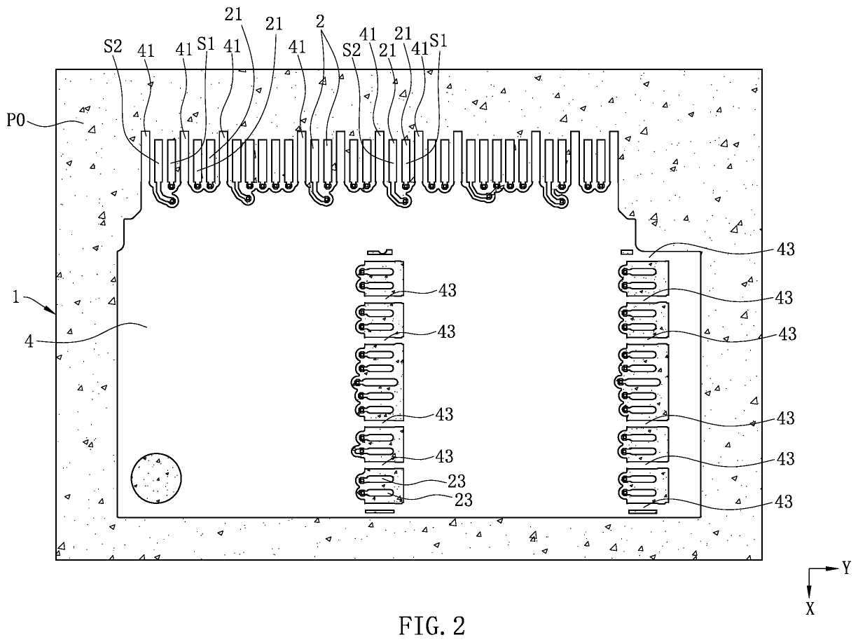

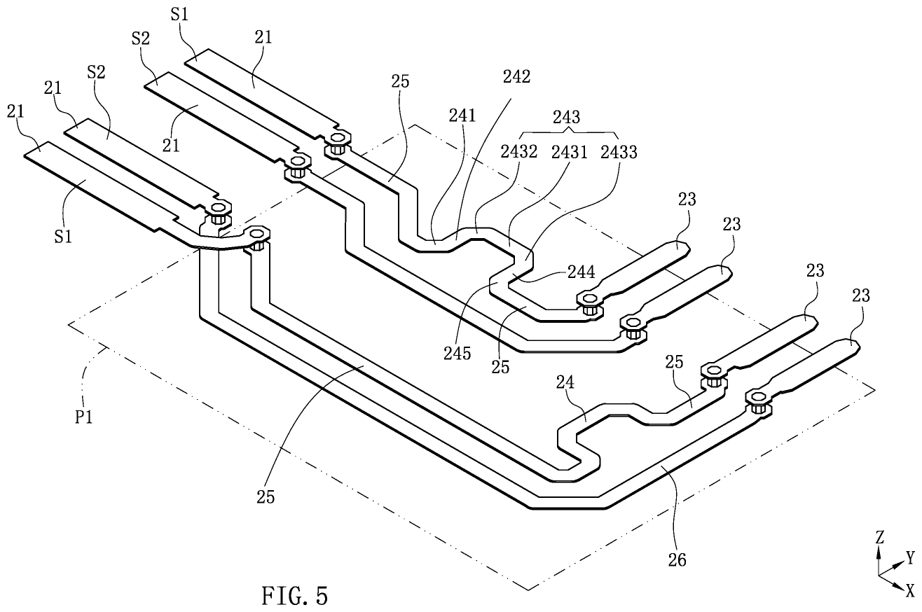

Referring to FIG. 2 and FIG. 5, for each of the first channel S1 and the second channel S2, an extending direction of the contact portion 21 and an extending direction of the conducting portion 23 are perpendicular to each other, and the middle portion 22 bends and extends between the contact portion 21 and the conductive portion 23. Thus, the transmission board may form an orthogonal-type transmission board, such that the first electrical component and the second electrical component are orthogonal to each other and connected through the transmission board. The timing compensation section 24 is located in the middle portion 22 of the first channel S1, and the coupling section 26 is located in the middle portion 22 of the second channel S2. The length of the transmission path of the coupling section 26 is less than the length of the transmission path of the timing compensation section 24, and the lengths of the transmission paths of the first channel S1 and the second channel S2 are equal. In the application scenario of the orthogonal-type transmission board, if the timing compensation section 24 is not provided, the length of the transmission path of the first channel S1 is apparently less than the length of the transmission path of the second channel S2. In the present embodiment, the length of the transmission path of the first channel S1 may be compensated by the timing compensation section 24 in the scenario, and the lengths of the transmission paths of the pair of the differential channels 2 are equal, thus reducing the signal transmission time delay between the pair of the differential channels 2 to the maximum degree. In particular, for the transmission board transmitting high frequency signals, a tiny transmission time delay may result in signal distortion or misjudgement, and the present embodiment, when being applied in the high frequency transmission environment, may effectively prevent from the signal distortion or misjudgment due to the transmission time delay of the differential signals.

Referring to FIG. 4 and FIG. 6, in the first channel S1 and the second channel S2 being arranged in pairs, viewing along a side-by-side direction of the timing compensation section 24 and the second channel S2, the grounding structure 3 and a projection of the inner side 27 of the timing compensation section 24 overlap with each other, and the grounding structure 3 and a projection of the inner side 27 of the second channel S2 overlap with each other. In addition, viewing from an observation direction perpendicular to the side-by-side direction and the perpendicular direction, the grounding structure 3 is located between the inner side 27 of the timing compensation section 24 and the inner side 27 of the second channel S2. In the present embodiment, the grounding structure 3 has a grounding potential surface to face with the inner side 27 of the timing compensation section 24 and the inner side 27 of the coupling section 26, allowing the grounding structure 3 to be closer to the first channel S1 and the second channel S2, more effectively adjusting the capacitance effect of the timing compensation section 24 and the coupling section 26, more effectively adjusting the impedance of the timing compensation section 24 and the impedance of the coupling section 26, and further more effectively improving the impedance consistency of the first channel S1 and the second channel S2. It should be noted that, for different pairs of the differential channels 2, since the location of the timing compensation section 24 and the extending way of the first channel S1 are different, “the side-by-side direction of the timing compensation section 24 and the second channel S2” may be different, and thus “the observation direction perpendicular to the side-by-side direction and the perpendicular direction” will be different. When the coupling section 26 extends in a straight line, “the observation direction perpendicular to the side-by-side direction and the perpendicular direction” refers to the length direction of the coupling section 26. For example, in the present embodiment, as shown in FIG. 4, for a shorter pair of the differential channels 2, the side-by-side direction of the timing compensation section 24 and the second channel S2 is the Y-axis direction, and the observation direction is the X-axis direction. For another longer pair of the differential channels 2, the side-by-side direction of the timing compensation section 24 and the second channel S2 is the X-axis direction, and the observation direction is the Y-axis direction.

Referring to FIG. 4 and FIG. 6, the grounding structure 3 includes a grounding conducting layer 31 and a grounding hole 32. The grounding conducting layer 31 is parallel to the board surface P0 of the transmission board, the grounding hole 32 is concavely provided along the perpendicular direction, and an inner wall of the grounding hole 32 is provided with a conducting material 321 connected to a ground potential. In other embodiments, the grounding structure 3 may be provided with only the grounding hole 32 and not the grounding conducting layer 31, or may be provided with only the grounding conducting layer 31 and not the grounding hole 32. For example, when the timing compensation section 24 has only one end being connected to the connecting section 25, and the other end being a free tail end of the first channel S1, the grounding structure 3 is provided with only the grounding conducting layer 31, and in order to make the grounding conducting layer 31 be grounded, an outer side 28 of the free tail end of the first channel S1 may be provided with a connecting hole, thus connecting the grounding conducting layer to other grounding coating layers through the connecting hole to facilitate the grounding. In this case, the connecting hole is not provided between the timing compensation section 24 and the second channel S2, so the grounding structure 3 is provided with only the grounding conducting layer 31. It should be noted that the grounding hole 32 may be a through hole, or may be a blind hole, as long as it is provided by removing a portion of the material of the insulating carrier 1 and the inner wall thereof is provided with the conducting material 321 connected to the ground potential. Thus, the grounding conducting layer 31 may be utilized to easily form a grounding potential plane with a certain area on the transmission board, which has more area to absorb outer interference signals, thus shortening the distances between the grounding structure 3 and the timing compensation section 24 and between the grounding structure 3 and the second channel S2, and helping adjusting the impedances. For the grounding hole 32, since the grounding hole 32 removes a portion of the insulating material surrounding the timing compensation section 24 and the second channel S2, and the inner wall thereof is provided with the conductive material 321 being grounded, which may adjust the equivalent dielectric constant of the material surrounding the timing compensation section 24 and the second channel S2, and the distances from the timing compensation section 24 and the coupling section 26 to the grounding potential. Thus, the capacitance effect may be changed comprehensively and synergistically by adjusting the equivalent dielectric constant and the distances, preventing the impedances of the timing compensation section and the corresponding sections from being excessively low or excessively high, which is conducive to improving the impedance consistency of the first channel S1 and the second channel S2 at various locations thereof. In other embodiments, the grounding structure 3 may not be the metal coating layers formed in the transmission board, and instead is a metal structure being inserted or molded in the transmission board, where the metal structure is grounded.

Referring to FIG. 4, viewing along the perpendicular direction, a distance between an outer side edge 33 of the grounding structure 3 and the inner side 27 of the timing compensation section 24 (that is, the third distance D3) is equal to a distance between the distance between the outer side edge 33 of the grounding structure 3 and the inner side 27 of the second channel S2 (that is, the fourth distance D4). Thus, it helps the impedance matching of the first channel S1 and the second channel S2 in the respective transmission paths thereof, and by D3=D4, it helps equalizing the impedance and the electric field between the first channel S1 and the second channel S2, and helps the impedance matching between the first channel S1 and the second channel S2, thus facilitating the signal coupling between the pair of differential channels 2. Further, the grounding structure 3 has an outer side edge 33 provided to be adjacent to the inner side 27 of the timing compensation section 24, and lines of the inner side 27 of the timing compensation section 24 and lines of the outer side edge 33 correspond with each other. Thus, viewing along the perpendicular direction, in the overall extending direction of the timing compensation section 24, a portion of the grounding structure 3 is located between the timing compensation section 24 and the coupling section 26 of the second channel S2, thus more effectively adjusting the impedance of the timing compensation section 24 at each location, and the impedance of the coupling section 26 of the second channel S2 at each location. It should be noted that, in the present embodiment, the outer side edge 33 of the grounding structure 3 is the outer side edge 33 formed on the grounding conducting layer 31, and the outer side edge 33 of the grounding conducting layer 31 extends in a polygonal-shaped line, the outer side edge 33 of the grounding structure 3 is adjacent to the inner side 27 of the timing compensation section 24, and the lines of the inner side 27 of the timing compensation section 24 and the lines of the outer side edge 33 correspond with each other. In other embodiments, the grounding structure 3 may have only the grounding hole 32. In this case, the outer side edge 33 of the grounding structure 3 is an arc-shaped side edge surrounded by the conductive material 321 of the grounding hole 32, and the inner side 27 of the timing compensation section 24 may be in the arc line coincided with the arc-shaped side edge. It should be noted that the inner side 27 of the timing compensation section 24 is defined to include a first line section a1, a second line section a2, a third line section a3, a fourth line section a4 and a fifth line section a5, and the outer side edge 33 is provided with line sections one-to-one corresponding to the first line section a1, the second line section a2, the third line section a3, the fourth line section a4 and the fifth line section a5, such that the lines of the inner side 27 of the timing compensation section 24 and the lines of the outer side edge 33 correspond with each other. It is also possible not to limit the quantity of the line sections. That is, when the shape of the outer side edge 33 and the shape of the inner side 27 of the timing compensation section 24 are substantially complementary with each other, it is deemed that the lines of the inner side 27 of the timing compensation section 24 and the lines of the outer side edge 33 correspond with each other.

Further, the coupling section 26 of the second channel S2 extends in a straight line, and the timing compensation section 24 includes a first turning section 241 connected to one of the connecting sections 25 and extending toward a direction away from the coupling section 26, a first perpendicular section 242 connected to the first turning section 241 and perpendicular to the coupling section 26, a second perpendicular section 244 separated from and parallel to the first perpendicular section 242, a second turning section 245 connecting the second perpendicular section 244 and the other of the two connecting sections 25, and a linking section 243 connecting the first perpendicular section 242 and the second perpendicular section 244. In the present embodiment, the linking section 243 has a third turning section 2432 connected to the first perpendicular section 242, a parallel portion 2431 connected to the third turning section 2432 and parallel to the coupling section 26, and a fourth turning section 2433 connected to the second perpendicular section 244 and the parallel portion 2431. In other embodiments, the linking section 243 may be provided without the third turning section 2432 and the fourth turning section 2433. Further, the distance between the outer side edge 33 of the grounding structure 3 and the inner side 27 of the first turning section 241, the distance between the outer side edge 33 of the grounding structure 3 and the inner side 27 of the first perpendicular section 242, the distance between the outer side edge 33 of the grounding structure 3 and the inner side 27 of the parallel portion 2431, the distance between the outer side edge 33 of the grounding structure 3 and the inner side 27 of the second perpendicular section 244, and the distance between the outer side edge 33 of the grounding structure 3 and the inner side 27 of the second turning section 245 are all equal. Compared to the case where the timing compensation section 24 is a smooth arc-shaped structure, in the present embodiment, the timing compensation section 24 is in a polygonal shape with multiple sections bending and extending, which is convenient to forming the timing compensation section 24 with a complete path by coating in the transmission board, and the timing compensation section 24 may extend with more length in a certain distance bulging outward relative to the coupling section 26, further better compensating the transmission path of the first channel S1 in the limited space, reducing the length difference between the transmission paths of the first channel S1 and the second channel S2, and reducing the transmission time delay of the pair of differential channels 2.

Referring to FIG. 2 and FIG. 3, the transmission board further includes a plurality of grounding channel 4 provided in the insulating carrier 1. Each grounding channel 4 includes a first grounding finger portion 41 located in the first layer and provided to be adjacent to the contact portions 21 of the pair of the differential channels 2, a grounding extending portion 42 located in the second layer and provided to be adjacent to the middle portions 22 of the pair of the differential channels 2, and a second grounding finger portion 43 located in the first layer and provided to be adjacent to the conductive portions 23 of the pair of the differential channels 2. In the present embodiment, the first grounding finger portion 41 and the second grounding finger portion 43 located in the first layer are connected to the grounding channels 4 located in the second layer through the connecting holes. A first grounding finger portion 41 is provided between the contact portions 21 of two adjacent pairs of the differential channels 2, a grounding extending portion 42 is provided between the middle portions 22 of two adjacent pairs of the differential channels 2, and a second grounding finger portion 43 is provided between the conductive portions 23 of two adjacent pairs of the differential channels 2. In the present embodiment, the grounding channels 4 are connected integrally. In other embodiments, the grounding channels 4 may be separately distributed without being integrally communicated, and are thus not limited thereto. It should be noted that, in other embodiments, the first grounding finger portion 41, the second grounding finger portion 43 and the grounding extending portion 42 of a same grounding channel 4 may be distributed in a same layer of the transmission board, or may be distributed respectively in three different layers, without being limited thereto.

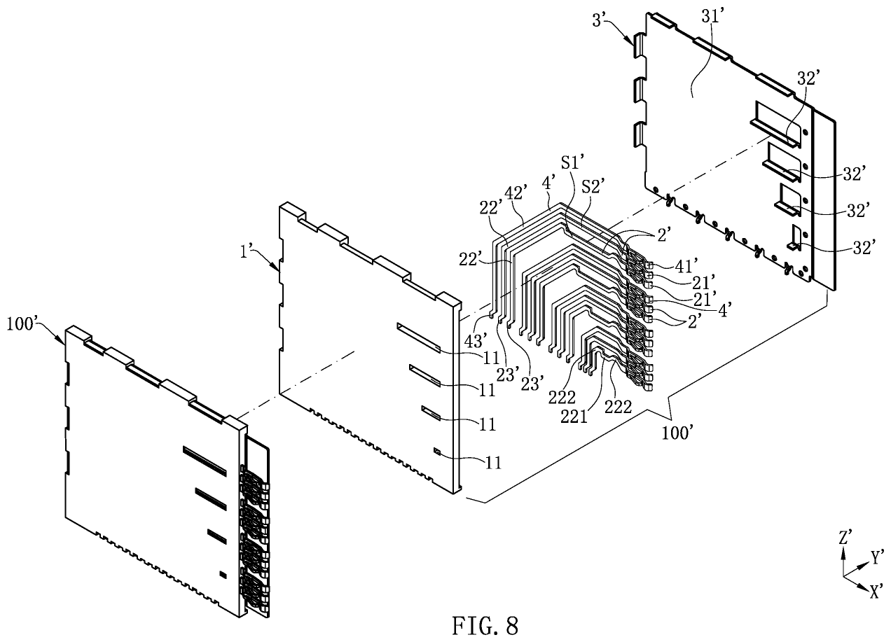

FIG. 8 to FIG. 11 show a connecting member 100′ according to a third embodiment of the present invention. For convenience of understanding the technical solutions of the third embodiment of the present invention, in the accompanying drawings, a three-dimensional coordinate with an X′-axis, a Y′-axis and a Z′-axis is added, and each two of the three axes are perpendicular to each other. In the third embodiment, the connecting member 100′ includes an insulating carrier 1′ and a plurality of pairs of differential terminals 2′ provided in the insulating carrier 1′, and each pair of the differential terminals 2′ include a first terminal S1′ and a second terminal S2′ used to support a pair of differential signals and provided adjacent to each other. An inner side 24′ of the first terminal S1′ and an inner side 24′ of the second terminal S2′ are coupled to each other, and an outer side 25′ of the first terminal S1′ and an outer side 25′ of the second terminal S2′ are the two outer sides of the pair of the differential terminals 2′ facing away from each other. Each of the first terminal S1′ and the second terminal S2′ has a contact portion 21′ in contact with a first electrical component (not illustrated, same below), a conductive portion 23′ in contact with a second electrical component (not illustrated, same below), and a middle portion 22′ connected to the contact portion 21′ and the conductive portion 23′. The middle portion 22′ of the first terminal S1′ and the middle portion 22′ of the second terminal S2′ are located on a same plane P1′, and the plane P1′ is parallel to a plane limited by the Z′-axis and the X′-axis in FIG. 8. The connecting member 100′ includes a shielding sheet 3′ located at one side of the plane P1′, and the shielding sheet 3′ is provided with a main body portion 31′ and a plurality of grounding structures 32′ extending from the main body portion 31′. The insulating carrier 1′ is provided with a plurality of recesses 11, and each recess 11 is used to accommodate and fix a corresponding one of the grounding structures 32′. In the third embodiment, the main body portion 31′ is a planar sheet body, and the main body portion 31′ may shield outer interference signals for the differential terminals 2′ of the connecting member 100′. The grounding structures 32′ may be, as shown in the present embodiment, formed by punching and tearing from the integral material of the shielding sheet 3′ and then bending. In other embodiments, the grounding structures 32′ may be separated materials from the main body portion 31′, which are fixed to the main body portion 31′ by fixing methods such as soldering, buckling, etc. The grounding structures 32′ may help improving the impedance consistency of the first terminal S1′ and the second terminal S2′, and may help fixing the shielding sheet 3′ and the insulating carrier 1′.

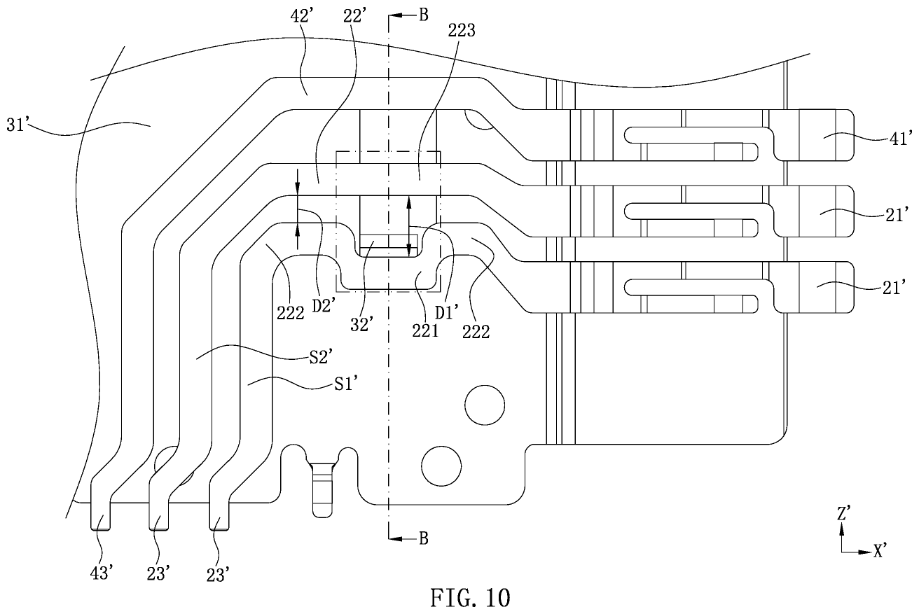

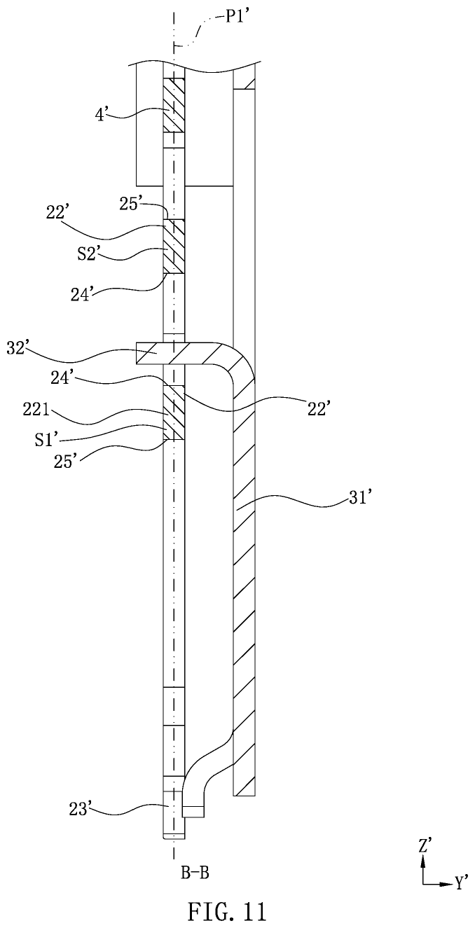

Referring to FIG. 10 and FIG. 11, in the third embodiment, for a pair of the differential terminals 2′, the middle portion 22′ of the first terminal S1′ includes a timing compensation section 221 and two connecting sections 222 connected to the timing compensation section 221. The timing compensation section 221 bends toward a direction away from the second terminal S2′ relative to the connecting section 222. A distance between an inner side 24′ of the timing compensation section 221 and the inner side 24′ of the second terminal S2′ is defined as a first distance D1′, a distance between an inner side 24′ of the connecting section 222 and the inner side 24′ of the second terminal S2′ is defined as a second distance D2′, and the first distance D1′ is greater than the second distance D2′. Each of the grounding structures 32′ extends toward a separation region between the inner side 24′ of the timing compensation section 221 and the inner side 24′ of the second terminal S2′ of a corresponding pair of the differential terminals 2′. Viewing in a perpendicular direction perpendicular to the plane P1′ (where the perpendicular direction is the Y′-axis direction in the drawings of the present embodiment), the grounding structure 32′ is located between the inner side 24′ of the timing compensation section 221 and the inner side 24′ of the second terminal S2′, and the grounding structure 32′ is not located between the inner side 24′ of the connecting section 222 and the inner side 24′ of the second terminal S2′. Thus, the length of the transmission path of the first terminal S1′ is extended by the timing compensation section 221, thus reducing the difference between the lengths of the transmission paths of the first terminal S1′ and the second terminal S2′, thereby reducing the signal transmission time delay of the first terminal S1′ and the second terminal S2′, facilitating processing and analysis of the system to the pairs of differential signals, and reducing the risks of signal loss or distortion. Meanwhile, by the grounding structure 32′ being provided between the timing compensation section 221 and the second terminal S2′, the equivalent dielectric constant of the material surrounding the timing compensation section 221 and the second terminal S2′ is adjusted. Thus, the capacitance effect between the timing compensation section 221 and the second terminal S2′ is adjusted, which facilitates the impedance matching of the first channel and the second channel at different locations thereof, improving the impedance consistency of the first terminal S1′ and the second terminal S2′ at different locations thereof, and reducing the signal reflection and loss. The principle for achieving related technical effects of the third embodiment is similar to the principle of the first embodiment, and is thus briefly described herein without being further elaborated in details. In the present embodiment, a plurality of the connecting members 100′ are arranged along the Y′-axis direction to form an overall connecting system (for example, forming a backplate connector), which is then in contact with the first electrical component and the second electrical component correspondingly. It should be noted that, in other embodiments, the connecting member 100′ may be designed such that only the first terminal S1′ of the pair of the differential terminals 2′ is provided with the timing compensation section 221, and in this case, the connecting member 100′ may have only one grounding structure 32′.

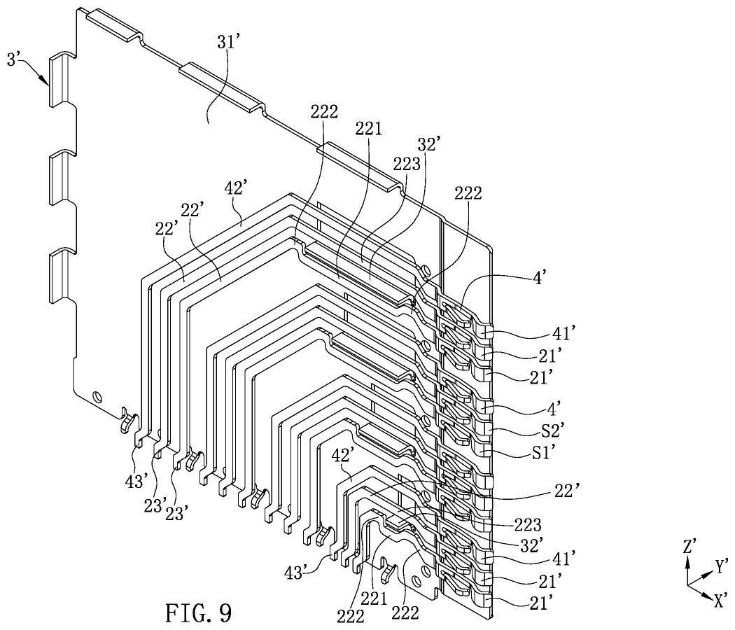

Referring to FIG. 9, FIG. 10 and FIG. 11, the second terminal S2′ has a portion corresponding to and side-by-side coupled to the timing compensation section 221 of the first terminal S1′, and the present invention refers to the portion as a coupling section 223. The coupling section 223 and the timing compensation section 221 face each other and are coupled to each other along a side-by-side direction. For convenience of understanding, referring to FIG. 10, the portion of the first terminal S1′ located in the dotted-line rectangular area is the timing compensation section 221, and the portion of the second terminal S2′ located in the dotted-line rectangular area is the coupling section 223. In the third embodiment, the grounding structure 32′ extends into the separation region between the inner side 24′ of the timing compensation section 221 and the inner side 24′ of the coupling section 223. In this case, viewing along the side-by-side direction, the grounding structure 32′ and a projection of the inner side 24′ of the timing compensation section 221 overlap with each other, and the grounding structure 32′ and a projection of the inner side 24′ of the second terminal S2′ overlap with each other. Meanwhile, viewing from an observation direction perpendicular to the perpendicular direction and the side-by-side direction, the grounding structure 32′ is located between the inner side 24′ of the timing compensation section 221 and the inner side 24′ of the second terminal S2′. Compared to the case where the grounding structure 32′ does not extend into the separation region, in the present embodiment, the grounding structure 32′ is closer to the timing compensation section 221 and the coupling section 223, thus more effectively adjusting the impedance of the timing compensation section 221 and the impedance of the coupling section 223. In the present embodiment, in each pair of the differential terminals 2′, the side-by-side direction of the coupling section 223 and the timing compensation section 221 is along the Z′-axis direction, and “the observation direction perpendicular to the perpendicular direction and the side-by-side direction” refers to the X′-axis direction. In other embodiments, the locations of the timing compensation sections 221 of different pairs of the differential terminals 2′ may be different, and the side-by-side directions and the observation directions thereof may be different.

Referring to FIG. 8 and FIG. 9, the connecting member 100′ further includes a plurality of ground terminals 4′, and one of the ground terminals 4′ is between two adjacent pairs of the differential terminals 2′. Each ground terminals 4′ has a first end portion 41′ used to be in contact with the first electrical component, a second end portion 43′ used to be in contact with the second electrical component, and a grounding extending portion 42′ connected to the first end portion 41′ and the second end portion 43′. The grounding extending portion 42′ and the middle portion 22′ of the first terminal S1′ as well as the middle portion 22′ of the second terminal S2′ are all on the plane P1′. In the present embodiment, for each of the first terminal S1 and the second terminal S2′, the extending direction of the contact portion 21′ and the extending direction of the conductive portion 23′ are perpendicular to each other, and the extending direction of the first end portion 41′ and the extending direction of the second end portion 43′ of the ground terminal 4′ are perpendicular to each other. Thus, the connecting member 100′ forms an orthogonal-type connecting structure. In this application scenario, the transmission path of the first terminal S1′ is apparently smaller than the transmission path of the second terminal S2′, and the technical solution provided by certain embodiments of the present invention may effectively improve the transmission time delay of the pair of differential signals and the impedance consistency of the pair of differential terminals 2′ in the application scenario.

It should be noted that, for a pair of differential terminals 2′, the lengths of the transmission paths of the first terminal S1′ and the second terminal S2′ may be provided equally. Alternatively, the lengths of the transmission paths of the first terminal S1′ and the second terminal S2′ may be unequal, as long as the timing compensation section 221 may relatively extend the transmission path of the first terminal S1′ compared to the case where the first terminal S1′ is not provided with the timing compensation section 221, thus relatively reducing the difference of the lengths of the transmission paths of the pair of the differential terminals 2′. In addition, in other embodiments, it is possible that the grounding structures 32′ do not form the shielding sheet 3′ with the main body portion 31′. For example, it is possible to provide independent strip-shaped grounding bars or independent smaller grounding thin sheets that are inserted between the first terminal S1′ and the second terminal S2′ and located between the inner side 24′ of the timing compensation section 221 and the inner side 24′ of the second terminal S2′, and portions of the material of the insulating carrier 1′ may be used to electrically isolate the grounding bars or the grounding thin sheets from the first terminal S1′ and the second terminal S2′. In this case, the grounding bars or the grounding thin sheets may function as the grounding structures 32′ of certain embodiments of the present invention. In addition, in other embodiments, the grounding structures 32′ may extend to be adjacent to the separation region without entering the separation region.

In the connecting member 100′ according to certain embodiments of the present invention, when the connecting member 100′ has a plurality of pairs of the differential conductors, the present invention does not require each of all of the first conductors in the pairs of the differential conductors to be provided with the timing compensation section 221, and it is possible to have the first conductor of one pair of the differential conductors is timing compensation section 221. For example, if the difference of the lengths of the transmission paths in one pair of the plurality of pairs of the differential conductors is not very large, even if there is signal transmission time delay, the timing still satisfies the system requirement without affect the system processing the signals. In this case, the technicians may selectively choose not to provide the timing compensation section 221 in the first conductor of the pair of the differential conductors. If the difference of the lengths of the transmission paths in another pair of the differential conductors is relatively larger, and the signal transmission time delay affects the system processing the signals, the technicians may choose to provide the timing compensation section 221 in the first conductor of the pair of the differential conductors. In the present embodiment, the distance between the grounding structure 32′ and the inner side 24′ of the timing compensation section 221 and the distance between the grounding structure 32′ and the inner side 24′ of the coupling section 223 is not equal. In other embodiments, the distance between the grounding structure 32′ and the inner side 24′ of the timing compensation section 221 and the distance between the grounding structure 32′ and the inner side 24′ of the coupling section 223 may be provided to be equal.

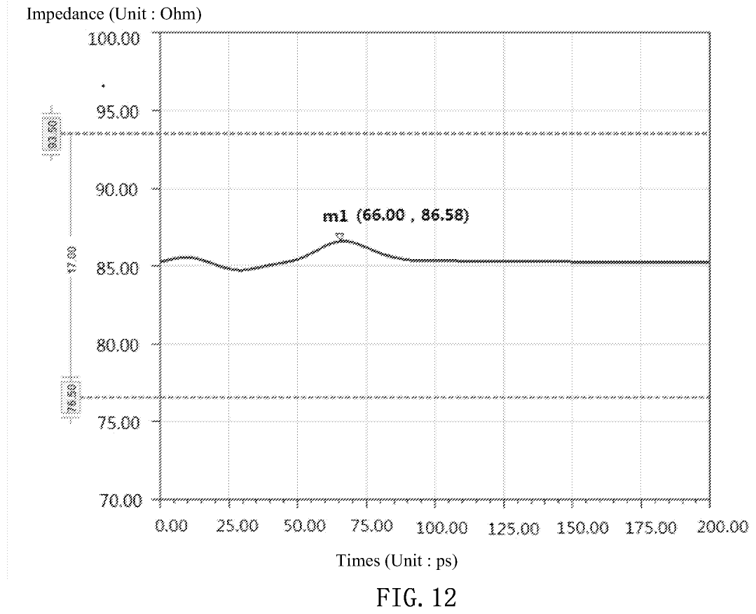

For convenience of understanding, the beneficial effects of the technical solutions according to certain embodiments of the present invention are described with reference to FIG. 12 to FIG. 14 as follows:

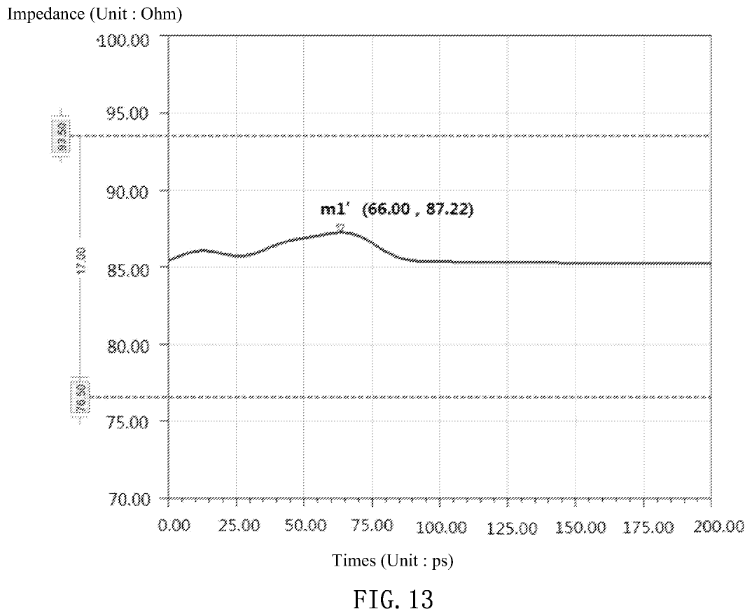

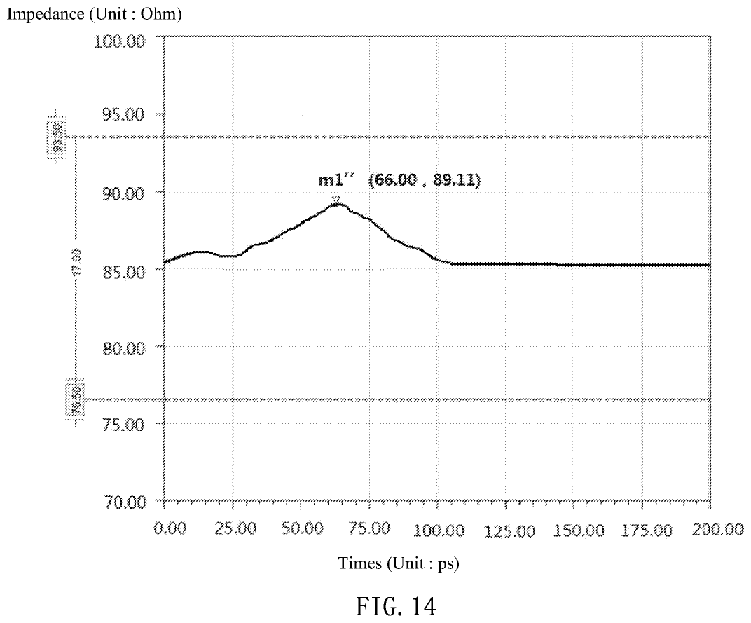

FIG. 12 is an impedance variance chart obtained by selecting one pair of the differential channels 2 from the transmission board 100 as shown in FIG. 1, and performing the simulation test to the first channel S1 thereof, where the grounding structure 3 between the timing compensation section 24 and the coupling section 26 of the pair of the differential channels 2 includes the grounding conducting layer 31 and the grounding hole 32. FIG. 13 is an impedance variance chart obtained by performing the simulation test to the first channel S1 of the selected one pair of the differential channels 2 when the grounding hole 32 of the grounding structure 3 of the transmission board 100 as shown in FIG. 1 is removed and only the grounding conductive layer 31 is maintained. FIG. 14 is an impedance variance chart obtained by performing the simulation test to the first channel S1 of the selected one pair of the differential channels 2 when the grounding structure 3 of the transmission board 100 as shown in FIG. 1 is removed as a whole (that is, the grounding conducting layer 31 and the grounding hole 32 are both removed). To ensure the accuracy of the tests, FIG. 12 to FIG. 14 show the result by performing the simulation tests to the first channel S1 at the same location in the transmission board 100, and only the grounding structure 3 of the transmission board 100 is changed. It should be noted that, although the horizontal coordinate of FIG. 12 to FIG. 14 refers to the time, since the time of the signal transmission to different locations of the first channel S1 is different, each chart of FIG. 12 to FIG. 14 reflects the impedance values of the first channel S1 at different locations thereof, where the vertical coordinates of the point m1, the point m1′ and the point m″ refer to the impedance values of the timing compensation section 24 of the first channel S1 at the same location thereof in the three conditions. It should be noted that the dotted line at 93.50 ohm refers to the impedance maximum value specified by the system, the dotted line at 76.50 ohm refers to the impedance minimum value specified by the system, and the dotted line at 85.00 ohm refers to the impedance central value specified by the system. That is, the closer it reaches 85.00 ohm, the more the impedance value of the first channel of the transmission board conforms to the system matching value, and the smaller the fluctuation amplitude of the waveform diagram, the better the impedance consistency of the first channel at each location thereof.

Referring to FIG. 12 to FIG. 14, in FIG. 12, when the grounding structure 3 includes the grounding conducting layer 31 and the grounding hole 32, the impedance value at the location m1 is 86.58 ohm, and the impedance fluctuation amplitude of the first channel S1 is the least. In FIG. 13, when the grounding structure 3 includes the grounding conducting layer 31 and does not include the grounding hole 32, the impedance value at the location m1′ is 87.22 ohm, and the impedance fluctuation amplitude of the first channel S1 is greater than the impedance fluctuation amplitude of the first channel S1 in FIG. 12, and is less than the impedance fluctuation amplitude of the first channel S1 in FIG. 14. In FIG. 14, when there is no grounding structure 3 between the timing compensation section 24 and the coupling section 26, the impedance value at the location m1″ is 89.11 ohm, and the impedance fluctuation amplitude of the first channel S1 is the greatest. It can be seen that, from FIG. 14 to FIG. 13 and then to FIG. 12, the impedance values at the locations m1″, m1′ and m1 are gradually reduced, the impedance value gradually reaches the impedance central value of 85.00 ohm specified by the system, and the impedance fluctuation amplitude is gradually reduced. Thus, it can be concluded that, compared to the case where there is no grounding structure 3 provided between the timing compensation section 24 and the coupling section 26, in the technical solution of certain embodiments of the present invention, by providing the grounding structure 3, the impedance of the timing compensation section 24 may be reduced, thus improving the impedance consistency of the first channel S1, thereby reducing the signal reflection and reducing the signal loss. Meanwhile, compared to the case where the grounding structure 3 includes only the grounding conducting layer 31, when the grounding structure 3 includes the grounding conducting layer 31 and the grounding hole 32, the reducing of the impedance of the first channel S1 and the improvement to the impedance consistency may be more significant and with better effect.

In sum, the transmission board and the connecting member according to certain embodiments of the present invention have the following beneficial effects:

1. The signal transmission time difference of the first conductor (that is, the first channel S1 or the first terminal S1′) and the second conductor (that is, the second channel S1 or the second terminal S1′) may be reduced by the timing compensation section 24, 221, thus facilitating processing and analysis of the system to the pairs of differential signals, and reducing the risks of signal loss or distortion. The capacitance effect between the timing compensation section 24, 221 and the second conductor S2, S2′ is adjusted by the grounding structure 3, 32′, thus improving the impedance consistency of the first conductor S1, S1′ and the second conductor S2, S2′ at different locations thereof, and reducing the signal reflection and loss.

2. Viewing along the side-by-side direction, the grounding structure 3, 32′ and the projection of the inner side of the timing compensation section 24, 221 overlap with each other, and the grounding structure 3, 32′ and the projection of the inner side of the second conductor S2, S2′ overlap with each other. In addition, viewing from the observation direction, the grounding structure 3, 32′ is located between the inner side of the timing compensation section 24, 221 and the inner side of the second conductor S2, S2′. Thus, the grounding structure 3, 32′ may be closer to the first conductor S1, S1′ and the second conductor S2, S2′, more effectively adjusting the capacitance effect of the timing compensation section 24, 221 and the coupling section 26, 223, more effectively adjusting the impedance of the timing compensation section 24, 221 and the impedance of the coupling section 26, 223, and further more effectively improving the impedance consistency of the first conductor S1, S1′ and the second conductor S2, S2′.

3. By D3=D4, it helps equalizing the impedance and the electric field between the first conductor S1, S1′ and the second conductor S2, S2′, and helps the impedance matching between the first conductor S1, S1′ and the second conductor S2, S2′, thus facilitating the signal coupling between the pair of differential conductors.

4. Viewing along the perpendicular direction, the lines of the outer side edge of the grounding structure 3, 32′ and the lines of the inner side of the timing compensation section 24, 221 correspond with each other. Thus, in the overall extending direction of the timing compensation section 24, 221, a portion of the grounding structure 3, 32′ is located between the timing compensation section 24, 221 and the coupling section 26, 223 of the second conductor S2, S2′, thus more effectively adjusting the impedance of the timing compensation section 24, 221 at each location, and the impedance of the coupling section 26, 223 of the second conductor S2, S2′ at each location.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A transmission board, comprising:
an insulating carrier;
a pair of differential channels, comprising a first channel and a second channel provided in the insulating carrier and adjacent to each other, wherein an inner side of the first channel and an inner side of the second channel are separated from each other and coupled to each other, the first channel has at least one timing compensation section and at least one connecting section connected to the timing compensation section, a distance between an inner side of the timing compensation section and the inner side of the second channel is defined as a first distance, a distance between an inner side of the connecting section and the inner side of the second channel is defined as a second distance, the first distance is greater than the second distance, and the timing compensation section bends toward a direction away from the second channel relative to the connecting section; and
at least one grounding structure, provided in the insulating carrier, wherein viewing along a perpendicular direction perpendicular to a board surface of the transmission board, the grounding structure is located between the inner side of the timing compensation section and the inner side of the second channel, and the grounding structure is not located between the inner side of the connecting section and the inner side of the second channel.

2. The transmission board according to claim 1, wherein each of the first channel and the second channel has a contact portion, a conducting portion and a middle portion bending and extending between the contact portion and the conducting portion, an extending direction of the contact portion and an extending direction of the conducting portion are perpendicular to each other, the timing compensation section is located in the middle portion of the first channel, the middle portion of the second channel has a coupling section, an inner side of the coupling section and the inner side of the timing compensation section face each other, a transmission path length of the coupling section is less than a transmission path length of the timing compensation section, and transmission path lengths of the first channel and the second channel are equal to each other.

3. The transmission board according to claim 1, wherein viewing along a side-by-side direction of the timing compensation section and the second channel, the grounding structure and a projection of the inner side of the timing compensation section overlap with each other, and the grounding structure and a projection of the inner side of the second channel overlap with each other; and viewing from an observation direction perpendicular to the side-by-side direction and the perpendicular direction, the grounding structure is located between the inner side of the timing compensation section and the inner side of the second channel.

4. The transmission board according to claim 1, wherein viewing from the perpendicular direction, a distance between an outer side edge of the grounding structure and the inner side of the timing compensation section is equal to a distance between the distance between the outer side edge of the grounding structure and the inner side of the second channel.

5. The transmission board according to claim 1, wherein the grounding structure has an outer side edge provided to be adjacent to the inner side of the timing compensation section, and lines of the inner side of the timing compensation section and lines of the outer side edge correspond with each other.

6. The transmission board according to claim 5, wherein the second channel has a coupling section extending along a straight line, an inner side of the coupling section and the inner side of the timing compensation section face each other, the first channel has at least two connecting sections, and the timing compensation section is connected between the two connecting sections;
the timing compensation section comprises a first turning section connected to one of the two connecting sections and extending toward a direction away from the coupling section, a first perpendicular section connected to the first turning section and perpendicular to the coupling section, a second perpendicular section separated from and parallel to the first perpendicular section, a second turning section connecting the second perpendicular section and the other of the two connecting sections, and a linking section connecting the first perpendicular section and the second perpendicular section, and the linking section has a parallel portion parallel to the coupling section; and
a distance between the outer side edge of the grounding structure and an inner side of the first turning section, a distance between the outer side edge of the grounding structure and an inner side of the first perpendicular section, a distance between the outer side edge of the grounding structure and an inner side of the parallel portion, a distance between the outer side edge of the grounding structure and an inner side of the second perpendicular section, and a distance between the outer side edge of the grounding structure and an inner side of the second turning section are all equal to one another.

7. The transmission board according to claim 1, wherein the first distance is not less than 1.5 times of the second distance, and the first distance is not greater than 3 times of the second distance.

8. The transmission board according to claim 1, wherein the grounding structure comprises a grounding conducting layer and/or a grounding hole, wherein the grounding conducting layer is parallel to the board surface of the transmission board, the grounding hole is concavely provided along the perpendicular direction, and an inner wall of the grounding hole is provided with a conducting material connected to a ground potential.

9. A connecting member, comprising:
an insulating carrier;
a first conductor and a second conductor, configured to support a pair of differential signals, wherein the first conductor and the second conductor are provided to be adjacent to each other and fixed to the insulating carrier, an inner side of the first conductor and an inner side of the second conductor are coupled to each other, each of the first conductor and the second conductor has a contact portion configured to be in contact with a first electrical component, a conducting portion configured to be connected to a second electrical component and a middle portion connecting the contact portion and the conducting portion, the middle portion of the first conductor and the middle portion of the second conductor are located on a same plane, the middle portion of the first conductor has at least one timing compensation section and at least one connecting section connected to the timing compensation section, the timing compensation section bends toward a direction away from the second conductor relative to the connecting section, a distance between an inner side of the timing compensation section and the inner side of the second conductor is defined as a first distance, a distance between an inner side of the connecting section and the inner side of the second conductor is defined as a second distance, and the first distance is greater than the second distance; and
a grounding structure, provided in the insulating carrier, wherein viewing along a perpendicular direction perpendicular to the plane, the grounding structure is located between the inner side of the timing compensation section and the inner side of the second conductor, and the grounding structure is not located between the inner side of the connecting section and the inner side of the second conductor.

10. The connecting member according to claim 9, wherein the connecting member is a circuit board, the grounding structure comprises a grounding conductive layer and/or a grounding hole, the grounding conductive layer is parallel to the plane, the grounding hole is concavely provided along the perpendicular direction perpendicular to the plane, and an inner wall of the grounding hole is provided with a conductive material connected to a ground potential.

11. The connecting member according to claim 9, wherein transmission path lengths of the first conductor and the second conductor are equal to each other, a portion of the second conductor and the timing compensation section face each other and are coupled to each other along a side-by-side direction; viewing along the side-by-side direction, the grounding structure and a projection of the inner side of the timing compensation section overlap with each other, and the grounding structure and a projection of the inner side of the second conductor overlap with each other; and viewing from an observation direction perpendicular to the perpendicular direction and the side-by-side direction, the grounding structure is located between the inner side of the timing compensation section and the inner side of the second conductor.

12. The connecting member according to claim 9, wherein viewing along the perpendicular direction perpendicular to the plane, a distance between an outer side edge of the grounding structure and the inner side of the timing compensation section is equal to a distance between the distance between the outer side edge of the grounding structure and the inner side of the second conductor.

13. The connecting member according to claim 9, wherein the grounding structure has an outer side edge provided to be adjacent to the inner side of the timing compensation section, and lines of the inner side of the timing compensation section and lines of the outer side edge correspond with each other.

14. The connecting member according to claim 9, wherein the first conductor and the second conductor are both terminal structures, the connecting member comprises a shielding sheet located at a side of the plane, the shielding sheet is electrically isolated from the first conductor and the second conductor, the shielding sheet is provided with a main body portion and the grounding structure extending from the main body portion toward a separation region between the inner side of the timing compensation section and the inner side of the second conductor.
